(19) United States
(12) Patent Application Publication
(10) Pub. No.: US 2015/0235154 A1
(43) Pub. Date: Aug. 20, 2015

(54) COMPUTERIZED METHOD AND SYSTEM AND METHOD TO PROVIDE BUSINESS PROCESS & CASE MODELING AND EXECUTION OF BUSINESS PROCESSES AND ACTIVITIES

(71) Applicant: Clemens UTSCHIG, Wiesbaden (DE)

(72) Inventor: Clemens UTSCHIG, Wiesbaden (DE)

(21) Appl. No.: 14/184,521

(22) Filed: Feb. 19, 2014

(51) Int. Cl. G06Q 10/06

(52) U.S. Cl. CPC G06Q 10/0637; G06Q 10/067

(57) ABSTRACT

A computerized system or method to provide business process or case modeling of business processes, wherein the method or system provides a method to reflect changes to a metamodel of activities, rules, interfaces and types within engine infrastructure components as well as physical data type systems at runtime, by the decoupling of technical instance state(s) and instance data from the physical process or workflow or case definitions and the meta-model modeling the business processes, in order to reflect changes to a metamodel of the business processes, including wherein the business model includes activities, rules, interfaces and types within engine infrastructure components and physical data type systems at runtime.

### FIELD OF THE INVENTION

The invention relates to business process and case modeling methods, systems, and software.

### BACKGROUND

Business Process Modeling:

(BPM) in systems engineering is the activity of representing processes of an enterprise, so that the current process may be analyzed and improved. BPM is typically performed by business analysts and managers who are seeking to improve process efficiency and quality. The process improvements identified by BPM may or may not require information technology involvement, although that is a common driver for the need to model a business process, by creating a process master. Business process modeling results in the improvement of the way tasks performed by the business. They can pick up errors or cons about the way processes are currently being performed and model an improved way of carrying out these processes.

Business Process:

A business process is a collection of related, structured activities or tasks that produce a specific service or product (serve a particular goal) for a particular customer or customers. There are three main types of business processes:

1. Management processes, that govern the operation of a system. Typical management processes include corporate governance and strategic management.

2 Operational processes, that constitute the core business and create the primary value stream. Typical operational processes are purchasing, manufacturing, marketing, and sales.

3. Supporting processes, that support the core processes can include accounting, recruitment, and technical support.

A business process can be decomposed into several sub-processes, which have their own attributes, but also contribute to achieving the goal of the super-process. The analysis of business processes typically includes the mapping of processes and sub-processes down to activity level. A business process model is a model of one or more business processes, and defines the ways in which operations are carried out to accomplish the intended objectives of an organization. Such a model remains an abstraction and depends on the intended use of the model. It can describe the workflow or the integration between business processes. It can be constructed in multiple levels.

Such BPM systems, methods, and software suffer from problems such as boundary limitations, after deployment of artifacts or descriptors, to changes to component configurations, graphs, and or type systems. Additional problems include instance migration and natural instance boundaries, wherein variables are used by a processor instance graph to make references to data structures and contents at runtime, where variables defined within the graph structure persist at runtime within the context and instance of a process or case which creates problems for migrating a new deployment to the new processor case model, in order to continue execution.

Accordingly, it is at least one object of the present invention to address, alleviate, improve and/or solve one or more of such problems, as well as additional problems.

### SUMMARY

The present invention solves current problems relating to BPM and/or Case systems, methods, and software suffer from problems such as boundary limitations, after deployment of artifacts or descriptors, to changes to component configurations, graphs, and/or type systems. Additional problems include instance migration and natural instance boundaries, wherein variables are used by a process and/or instance graph to make references to data structures and contents at runtime, where variables defined within the graph structure persist at runtime within the context and instance of a process and/or case which creates problems for migrating a new deployment to the new process and/or case model, in order to continue execution.

Non limiting embodiments of the present invention can solve such problems by providing a computerized system or method to provide business process and/or activity modeling of business processes and cases, wherein the method or system provides a method to reflect changes to a metamodel of activities, rules, interfaces and types within engine infrastructure components as well as physical data type systems at runtime, by the decoupling of technical instance state(s) and instance data from the physical process and/or workflow and/or case definitions and the meta-model modeling the business processes, in order to reflect changes to a metamodel of the business processes, including wherein the business model includes activities, rules, interfaces and types within engine infrastructure components and physical data type systems at runtime, the computerized method comprising one or more of:
a) electronically providing on non transitory computer readable media a case and/or workflow and/or process engine that analyzes computer data corresponding to the metamodel of the business processes; the engine electronically translating computer data corresponding to the process and/or workflow and/or case models of the business processes during deployment into machine and/or engine understandable code and configurations, and during runtime into physical process and/or cases instances as shown in FIG. 2;
b) electronically providing on non transitory computer readable media a database and/or storage system which stores the state of a running instance including the content of its variables and technical instance states, that provides tracking of the corresponding data during and after execution state in order to run modeling of the business processes;
c) electronically providing on non transitory computer readable media at least one artifact change subroutine provided through an API to deploy any changes and/or artifacts to the engine provided in step (a);
d) electronically providing on non transitory computer readable media at least one invocation subroutine provided through an API exposed via standard protocols at least one subroutine to invocate the engine to (i) create an accessible instance from a process and/or case model, through a defined API, the invocation subroutine initiated based on one or more of a trigger reflected within the process and/or case model, a user interface (UI), or another subroutine; and
e) electronically providing on non transitory computer readable media at least one external bindings subroutine to invoke or expose defined endpoints, web-services, or at least one external defined interface;
   optionally wherein the method includes changes comprising additions, removals and modifications to a process and/or workflow and/or case definition at runtime,
   optionally wherein the method, during its execution on multiple layers, does not include or require: (i) redeployment of contained components; and (ii) restart of: (A) deployed components, (B) execution engines, and (C) the migration of process and/or workflow and/or case instance data because of said changes; and
   optionally wherein ontologies, comprising one or more of shell, information, platform and service, is used to provide at least a portion of the metamodel that can be changed at runtime and includes configuring infrastructure components, systems, and a decoupling state, instance data from the business process and/or case modeling, case models and user interface (UI);
   optionally wherein the relationships between are solely interpreted during execution as connecting entities, and are together a generic meta-model for processes and case definitions;
   optionally wherein a deployable process and/or workflow and/or cases artifact uses artifacts, or a subset of said artifacts, comprising (i) a process and/or case model; (ii) references to external components; and (iii) variables; (iii) a deployment descriptor, which contains physical links to process artifacts; and (iv) a type model, represented through object definitions.

The method or system can optionally provide wherein said deployable process and/or workflow and/or cases artifact comprises one or more of SCA, BPMN, BPEL, or implementor dependent therein, or a deployable case. The method or system can optionally provide wherein the deployable cased is based on CMMN. A method according to claim 2, wherein said process and/or case model comprises a process graph with embedded activities selected from human tasks, service invocations, event consumers and/or providers, and data transformations. The method or system can optionally provide wherein said references to external components are selected from one or more of services, adapters, and variables. The method or system can optionally provide wherein said variables, based on one or more types of said type model. The method or system can optionally provide wherein said deployment descriptor comprises physical links to process artifacts. The method or system can optionally provide wherein said process artifacts comprise WSDL documents and wherein the WSDL documents define physical service endpoints. The method or system can optionally provide wherein the type model is represented through object definitions locally or referenced from other locations. The method or system can optionally provide wherein the object definitions are in the form of one or more of java classes, XML Schemas, or other type definition language.

The method or system can optionally provide wherein said non transitory computer readable media is provided on at least one selected from a computer processor, a computer, a computer network, a computer server, an API, a website hosting server or network, a mobile device, a WIFI network, a LAN network, a computer network access device, and a personal computer.

The method or system can optionally provide wherein said business processes are selected from management processes, operational processes and supporting processes. The method or system can optionally provide wherein said management processes govern the operation of a system and are selected from corporate governance and strategic management; wherein said operational processes comprise one or more of purchasing, manufacturing, marketing, and sales; and wherein said supporting processes comprise one or more of accounting, recruitment, and technical support.

The method or system can optionally provide wherein the subroutine in step (c) is provided through an API exposed via standard protocols. The method or system can optionally provide wherein said changes include (i) changes to artifacts selected from one or more of graph of activities selected from additions, sequence, and removal of activities; and (ii) type systems selected from new types, removed types, and changes, which includes deployment of these changes to the engine. The method or system can optionally provide wherein said ontologies comprise at least one of each of (i) a shell and/or activity and/or usecase ontology; (ii) an information ontology; (iii) a platform ontology; and (iv) a service ontology.

The method or system can optionally provide wherein (i) said shell and/or activity and/or usecase ontology includes modeling relationships between activities, usecases, and roles, and provides cluster activities; (ii) said information ontology comprises modeling entity (type) definitions and their relationships wherein said entities store links to physical type definitions and allow a runtime to decipher information objects (physical instances of data) into finer grained objects; and (iii) said platform ontology comprises modeling rules and preconditions that are attached to said activities which are evaluated during runtime; and (iv) said service ontology comprises modeling information providers and other external interfaces which can be used from within an activity; such that infrastructure components monitor the state of the meta-model ontology, and reconfigure themselves upon changes, addition of new interfaces, or new activities and/or usecases or rules, wherein the ontologies do not model any transitions in machine code or configurations between activities, and expresses dependencies between those through rules against information and/or data instances at runtime, wherein said process graphs & deployment boundaries are not limiting.

The method or system can optionally provide wherein said variables are defined within the graph structure and at runtime are linked to the context and instance of a process and/or case, wherein information is created during the execution of said activities, while being available to any other activity instance for reuse, wherein updating of information results in a new information object linked to the previous one through an explicit relationship via said ontologies, selected from (i) storing information within a knowledge base in a non relational way, annotated with metadata; and (ii) establishing and maintaining relationships between an activity instance and the said information object, as depicted in FIG. 4, wherein by this linkage at least one algorithm can preserve instances and their modifications over time, and independent of said process and/or case model, such that instance migration is not limiting and the natural instance boundary is not broken up.

Although the invention is illustrated and described herein as embodied in BPM systems, methods, and software, it is nevertheless not intended to be limited to the details shown, since various modifications and structural changes may be made therein without departing from the spirit of the invention and within the scope and range of equivalents of the claims

### FIGURE DESCRIPTIONS

FIG. 1 shows a schematic diagram of infrastructure components used within a process and/or case engine.

FIG. 2 shows a schematic diagram of the logical flow from a design time model (graph of activities, and transitions and/or rules) to runtime execution.

FIG. 3 shows a schematic diagram of a metamodel for processes and cases.

FIG. 4 shows a schematic diagram of relating information and/or data objects to each other through ontologies.

FIG. 5 shows in a diagram of a sample application for a business process management.

### DESCRIPTION

The present invention solves current problems relating to BPM systems, methods, and software suffer from problems such as boundary limitations, after deployment of artifacts or descriptors, to changes to component configurations, graphs, andand/oror type systems, as well as additional problems including instance migration and natural instance boundaries, wherein variables are used by a process and/or instance graph to make references to data structurs and contents at runtime, where variables defined within the graph structure and persist at runtime within the context and instance of a process and/or case which creates problems for migrating a new deployment to the new process and/or case model, in order to continue execution.

Non limiting embodiments of the present invention can solve such problems by providing a computerized system or method to provide business process and/or case modeling of business processes, wherein the method or system provides a method to reflect changes to a metamodel of activities, rules, interfaces and types within engine infrastructure components as well as physical data type systems at runtime, by the decoupling of technical instance state(s) and instance data from the physical process and/or workflow and/or case definitions and the meta-model modeling the business processes, in order to reflect changes to a metamodel of the business processes, including wherein the business model includes activities, rules, interfaces and types within engine infrastructure components and physical data type systems at runtime.

Business Process Modeling:

(BPM) in systems engineering is the activity of representing processes of an enterprise, so that the current process may be analyzed and improved. BPM is typically performed by business analysts and managers who are seeking to improve process efficiency and quality. The process improvements identified by BPM may or may not require information technology involvement, although that is a common driver for the need to model a business process, by creating a process master. Business process modeling results in the improvement of the way tasks performed by the business. They can pick up errors or cons about the way processes are currently being performed and model an improved way of carrying out these processes.

Business Process:

A business process is a collection of related, structured activities or tasks that produce a specific service or product (serve a particular goal) for a particular customer or customers. There are three main types of business processes:

1. Management processes, that govern the operation of a system. Typical management processes include corporate governance and strategic management.

2 Operational processes, that constitute the core business and create the primary value stream. Typical operational processes are purchasing, manufacturing, marketing, and sales.

3. Supporting processes, that support the core processes can include accounting, recruitment, and technical support.

A business process can be decomposed into several sub-processes, which have their own attributes, but also contribute to achieving the goal of the super-process. The analysis of business processes typically includes the mapping of processes and sub-processes down to activity level. A business process model is a model of one or more business processes, and defines the ways in which operations are carried out to accomplish the intended objectives of an organization. Such a model remains an abstraction and depends on the intended use of the model. It can describe the workflow or the integration between business processes. It can be constructed in multiple levels.

A workflow is a depiction of a sequence of operations, declared as work of a person, of a simple or complex mechanism, of a group of persons, of an organization of staff, or of machines. Workflow may be seen as any abstraction of real work, segregated into workshare, work split or other types of ordering. For control purposes, workflow may be a view of real work under a chosen aspect.

Artifact-Centric Business Process:

The artifact-centric business process model has emerged as a new approach for modeling business processes, as it provides a highly flexible solution to capture operational specifications of business processes. It particularly focuses on describing the data of business processes, known as “artifacts”, by characterizing business-relevant data objects, their lifecycles, and related services. The artifact-centric process modelling approach fosters the automation of the business operations and supports the flexibility of the workflow enactment and evolution.

Business Process Modeling Tools:

Business process modeling tools provide business users with the ability to model their business processes, implement and execute those models, and refine the models based on as-executed data. As a result, business process modeling tools can provide transparency into business processes, as well as the centralization of corporate business process models and execution metrics.

Modeling and Simulation:

Modeling and simulation functionality allows for pre-execution “what-if” modeling and simulation. Post-execution optimization is available based on the analysis of actual as-performed metrics, and can include: Use case diagrams, which is currently integrated in UML; and Activity diagrams, also currently adopted by UML. Some business process modeling techniques are: Business Process Model and Notation (BPMN); Cognition enhanced Natural language Information Analysis Method (CogNIAM); Extended Business Modeling Language (xBML); Event-driven process chain (EPC); ICAM DEFinition (IDEFO); Unified Modeling Language (UML), extensions for business process such as Erikson-Penker's, and the like.

Programming Language Tools for BPM.

BPM suite software provides programming interfaces (web services, application program interfaces (APIs)) which allow enterprise applications to be built to leverage the BPM engine. This component is often referenced as the engine of the BPM suite.

Programming languages that are being introduced for BPM include: BPMN; Business Process Execution Language (BPEL); Web Services Choreography Description Language (WS-CDL); and XML Process Definition Language (XPDL). Some vendor-specific languages include: Architecture of Integrated Information Systems (ARIS) supports EPC; Java Process Definition Language (JBPM); Other technologies related to business process modeling include model-driven architecture and service-oriented architecture.

The invention can include one or more aspects of a method or system for transductive training of a system by an user interaction that defines business applications as freely definable information structures of Descriptive Concept Patterns (DCP) and related pattern structures virtually representing a real-world environment of people, machines, robots, physical objects or abstract business entities and thus enabling transductive training via its interaction with users. The trained system or User-Trained Environment (UTE) enables user and/or machine and/or software interaction with those stored patterns by keyboard or touch-screen input or usage of provided Application Programming Interface (API). The UTE enables multiple User-Trained Agents (UTA) to learn machine control operations, business processes, data manipulation, interactive applications, communication and document-use by means of real-time Transductive Training from user interaction with those DCPs linked to the real world objects.

An UTE user—which can be any of or other than a machine operator, robot trainer, business clerk, business analyst or IT specialist, as well as another machine consumer—describes by means of physical interaction, written language or automated capture of business information freely-definable business or other concept patterns (DCPs) that are stored.

In the UTE, applications and processes are modeled as an open-world state-space of operations- or business-relevant concepts. The training on the items is performed by user and/or system interaction—referred to as Activity Mining (AM)—on the state-space.

The UTE enables the user to interact with the Descriptive Concept Patterns (DCP) and collect training information by performing activities that change the state of relevant patterns, hence Activity Mining. Activity Mining is performed either by user action on a machine or by direct user input that modify the state-space of the related DCPs, relationship patterns, item location patterns, machine function patterns, user activity patterns, process patterns, partial-order patterns, presentation patterns, real-time transaction data patterns and previously trained knowledge patterns.

The UTE software uses a structured bitmap pattern to describe concepts and simply moves the binary bitmap pattern from the internal memory of computer to pattern storage. A global unique identifier (GUID) is used to uniquely identify each pattern and each new version or variant of a pattern. For use of those patterns in a distributed computer network they are binary copied as proxies to other UTE patterns storage nodes.

Training and execution are both performed within the productive environment of the UIE without the need for intermediate knowledge engineering. An operational or business activity that reaches a point of exception, meaning that it has no previously trained decision pattern that matches the current state-space pattern, will stop and wait for user training. The User-Trained Agent (UTA) is able to execute the trained knowledge on different instances of the same DCPs as well as by means of identified analogies or similarities of DCPs in the pattern storage.

One object of the invention is a method for training a system to specifically react on a specific input in real-time. Another object of the invention is a computer system designed to execute the method. A further object of the invention is a computer program product on non transitory computer readable media for enabling the computer system to execute the method.

According to the invention binary data structures, representing an abstract description of a certain type of a real-world component, are directly stored as a binary pattern in a computer memory or non-transitory storage memory. The data structures are not described as compiled machine-code or interpreted logic language based on a Boolean logic with data stored in database tables or as a rule-based expert or business process system that requires knowledge to be encoded in fact and belief knowledge rules—whether coded ore induced—but as freely definable binary clusters of concept patterns and pattern structures virtually representing a real-world system of abstract business entities that enable multiple User-Trained Agents (UTA) to learn business processes, data manipulation, interactive applications and communication and document use by means of real-time transductive training from user interaction with those patterns.

By creating uniquely identifiable copies of the binary data structures to represent individual instances of the types of components and creating a virtual state space of said individual types of components by grouping them as relevant for the specific situation, and storing received changes as a new version of the respective data structure, similarities of the binary patterns stored and related to a particular action performed could be found in real-time by analyzing directly the stored binary clusters.

A User-Trained Agent or UTA used in the UTE is a kind of agent that not only monitors the state-space for changes to act, but directly learns from user action on abstract concepts in the state-space in real-time. Such a new agent has to be able to observe the state-space in real-time and to identify each element, its value, location and references in the state-space and map it to user-role action and calculate a relevance of properties to the perceived action in real-time.

The UTA agent technology can observe the data-patterns and their meta-data concept definitions within the execution environment without being assigned predetermined and action sequences from an agent knowledge base. Therefore, the UTA can deal in real-time with non-deterministic or stochastic interference, as well as uncertain, partially observable, non-strategic, non-sequential, non-discrete and non-static state-spaces.

For practical flexibility and more accurate process knowledge, the UTE utilizes a root container to reference all relevant business operation DCP instances that represent a state-space of patterns consisting of positive literals that must be ground- and function-free. UTE concepts allow an open-world assumption meaning that not all states that are currently unknown must be false or that all concepts participating in the case must be known beforehand. In the UTE, the user can add new concept patterns and new states of concept patterns at any time. Goals and mandatory functions are represented as a partially specified state-space or sequence, represented by a conjunction of positive ground literals defined by means of a pattern query language (PQL).

In UTE such actions are trained by the user by automatically identifying over time the not-relevant elements and type-relevant elements of the state-space for a particular repeating action. Through continuous input by the user, the UTA is capable of learning from the user activity what these pre-conditions are without any additional information. The UTE can alternatively use parseable or interpreted action description languages such as STRIPS, ADL or PDDL to describe possible actions.

The UTA has the advantage that activities do not have to be performed in a rigid chronological sequence but can be dissected into several sub-plans or activities.

The UTA does create an implicit order of actions within a state-space by means of decision patterns but does not use partial-order planning concepts such as GRAPHPLAN, SATPLAN or BLACKBOX.

The UTA is also an innovation on what is called a CONTINUOUS PLANNING AGENT or CPA that is in principle able to react to events and can revise plans in real-time as new work-items or goals are added. A CPA is capable of beginning to execute a plan before it is complete and revise the plan as it is executed. The UTA innovates on the idea of a CPA in the sense that it asks the UTE user for training input in case of indeterminable decisions and learns from those interactions without the need for a knowledge engineer to encode new ACTION items.

The UTA is trained by means of exceptions that do not match a previously trained decision-pattern for the state-space. Such exception-based learning is considered by CASE BASED PLANNING in which plans are computed and reused as an analogy based on similar encountered exceptions but in difference to the UTE not interactively user trained.

The UTE innovates on the state-of-the-art and solves known performance problems by using a binary pattern structure that represents concepts rather than trying to interpret knowledge from program language. The UTE is trained by human operator decisions on the state-space and learns to act the same way without knowing or trying to understand why. It only recognizes similar state-space situations without logical reasoning. This is apparently how humans make decisions as well.

Multiple UTAs however, do not communicate but see each other's actions as stochastic state-space changes. The UTA can act independently on state-spaces or subsets thereof much as the human-brain does. Alternatibvely, state-of-the-art agents can be used that require specialized encoded knowledge sets and communicate to create an overall workflow, such as the ADEPT system. These systems require a data-gathering, analysis, design and rule creation phase to determine the partial-order plans of the overall business process in a Procedural Reasoning System.

The UTE can optionally assume that each agent has some ingrained knowledge that he uses to execute a certain task and communicates with other agents to some extent. The UTA is in difference a software component that monitors a state-space that contains items with associated possible actions and learns from the user interaction with those.

In the UTE, the UTAs cooperate without the need for knowing each other and the requirement to create joint plans. There is NO direct agent-to-agent communication and coordination necessary except for generic notification events. By means of agents observing different state-spaces and having different role authority, a segmentation of any complex business case is automatically achieved.

User-to-agent, agent-to-agent, and agent-to-user communication is not explicit by means of a predefined communications protocol but can be performed by means of any pattern that becomes part of the stochastic state-space, such as language (vocal, text or data and even XML), or images (documents, pictures or video). Previously trained patterns will cause either to goal-mismatch events or change the state of any object in a state-space monitored by an UTA. Language patterns can be stereotyped to reference queries, action requests, acknowledgements or commitments without induction as of to why that is the case.

The User-Trained Environment or UTE performs as a distributed peer-to-peer system with a central versioning concept repository to store the descriptive concept patterns (DCPs). The UTE represents a distributed peer-to-peer system of identical node-programs that select binary representations of concept and instance patterns from a central, version-controlled repository based user authorization or as selected by the trained knowledge patterns.

An UTE user—which can be any of or other than a machine operator, robot trainer, business clerk, business analyst or IT specialist—describes by means of physical interaction, written language or automated capture of business information freely-definable business or other concept patterns (DCPs) that are stored in a proprietary bitmap format in a central pattern storage (repository) and identically executed as-is by the UTE transactional kernel code without transcoding or compilation on every operating system that the UTE kernel runs on.

In the UTE, machines, physical objects, plant operations, applications and processes are modeled as an open-world state-space of operations- or business-relevant concepts identified by bitmap-patterns, whose state is relevant to the summary state of the process, plan or case.

In a preferred embodiment the method further comprises storing the received changes as a new version of the respective data structure while retaining the previous version in said binary pattern in said computer memory or disk memory. This enables the evolution of the respective data structure.

According to another embodiment of the invention in a training phase actions performed on the individual components, items or virtual objects are received by an identified type of operator via keyboard input, sensor devices or other technical means, and a decision pattern map of all data structures is created in the virtual state space for each repeatedly received action. During this training phase the identified operator trains the system on specific actions related to a specific input. To create a decision pattern map of the data structures for each repeatedly received action will allow a faster identification of later similar data structures. The training on the items could be performed by real-time user interaction—referred to as Activity Mining (AM)—on the state-space though mapped sensors and input devices rather than posthumous data mining.

According to another embodiment during the training phase only changes in the virtual state space caused by a specific action are collected and other automatically generated changes are excluded from collection. In this case the system is only trained on specific changes or specific input. The changes caused by a specific action are preferably distinguished from other changes by marking or by a heuristic method scanning the actions done for typical characteristics.

The Artifact-Centric Business Process and/or Case Model represents an operational model of business processes and/or cases in which the changes and evolutions of business data, or business entities or activities, are considered as the main driver of the processes. Different from current modeling approaches, called Activity-centric or Process-Centric business process and/or case modeling, the Artifact-centric approach focuses on describing how business data is change and/or updated, by a particular action or task, throughout the process.

In general, a process and/or case model describes activities conducted in order to achieve business goals, informational structures, and organizational resources. Workflows, as a typical process and/or case modelling approach, often emphasize the sequencing of activities (i.e., control flows), but ignore the informational perspective or treat it only within the context of single activities. Without a complete view of the informational context, business actors often focus on what should be done instead of what can be done, hindering operational innovations.

Business process and/or case modeling is a foundation for design and management of business processes. Two key aspects of business process and/or case modeling are a formal framework that integrates both control flow and data, and a set of tools to assist all aspects of a business process life cycle. A typical business process life cycle includes at least a design phase, concerned with the “correct” realization of business logic in a resource-constrained environment, and an operational phase, concerned with optimizing and improving execution (operations). Traditional business process and/or case models emphasize a procedural and/or graph-based paradigm (i.e., control flow). Thus, methodologies to design workflow in those models are typically process-centric. It has been argued that a data-centric perspective is more useful for designing business processes in the modem era.

Intuitively, business artifacts (or simply artifacts) are data objects whose manipulations define the underlying processes in a business model. Recent engineering and development efforts have adopted the artifact approach for design and analysis of business models. An important distinction between artifact-centric models and traditional data flow (computational) models is that the notion of the life cycle of the data objects is prominent in the former, while not existing in the latter.

In artifact based business process and/or case modeling and simulation information technologies, a deployable process and/or workflow and/or case artifact (e.g., based on either an industry standard such as, but not limited to, BPMN or BPEL; or implementor dependent), or a deployable case (based on CMMN or implementor dependent) optionally contains one or more of the following artifacts, or one or more subsets thereof:
a) A process and/or case model (process graph, with embedded activities (such as, but not limited to, human tasks, service invocations, event consumers and/or providers, data transformations), references to external components such as services, adapters as well as variables, based on types defined in (c))
b) A deployment descriptor which can contain the physical links (e.g., local, IP address and/or URLs) to other process artifacts, such as as type systems, but not limited to, WSDL documents (which themselves define physical service endpoints) and
c) A type model, represented through object definitions (in the form of java classes, XML Schemas, or any other known type definition language) either locally or referenced from other locations and artifacts

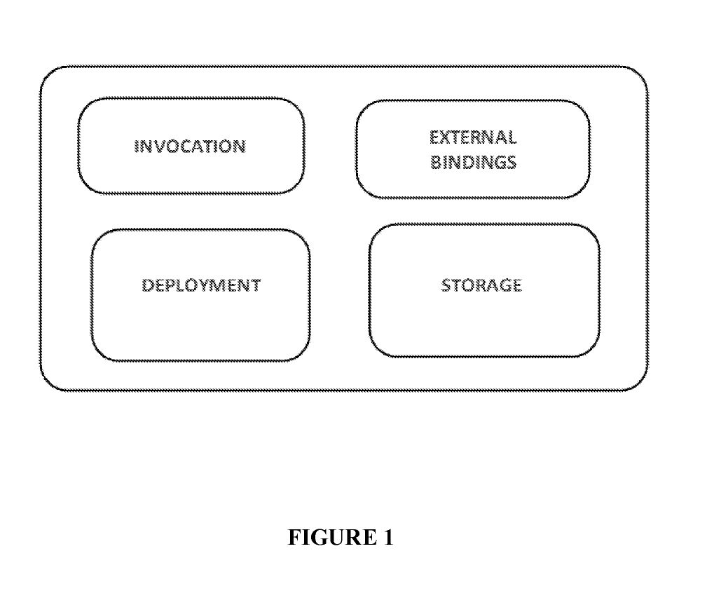

In order to execute such a model and create instances at runtime, the above infrastructure components (FIG. 1) are required:

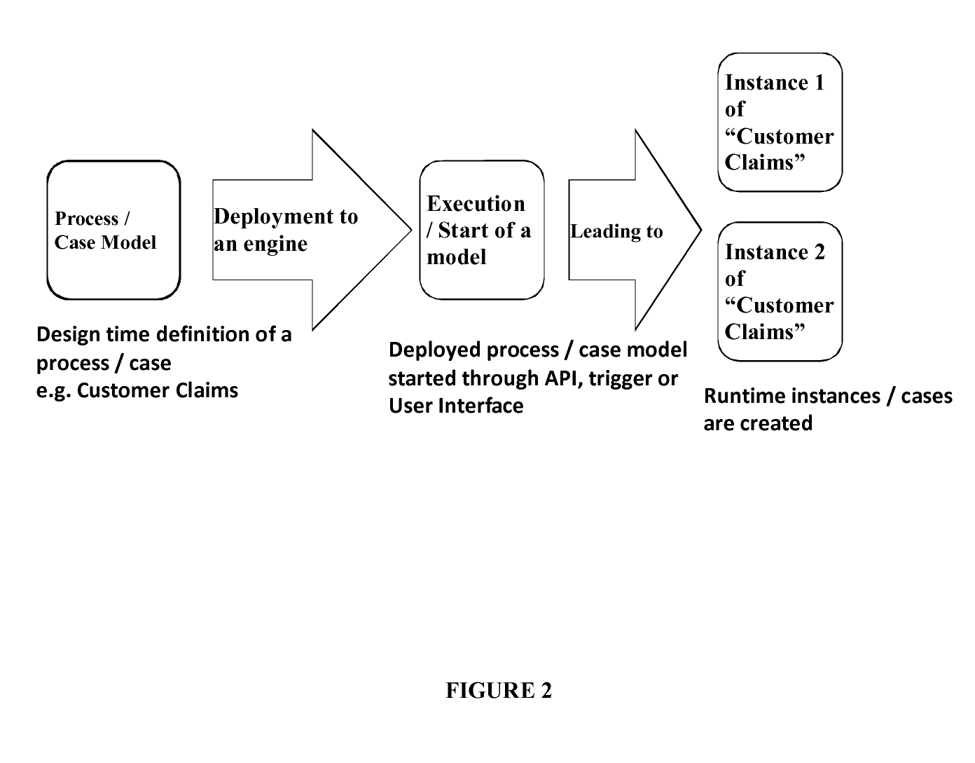

a) An engine (case and/or workflow and/or process engine) being able to interpret such a model and translate process and/or workflow and/or case models during deployment into machine and/or engine understandable code and/or configurations, and during runtime into physical process and/or cases instances—FIG. 2.

b) A database and/or storage system (storage) which stores the state of a running instance (the content of its variables, as well as technical instance state), to ensure during and after execution state track-ability.

c) A mean (deployment) to deploy any changes and/or artifacts to the engine named in (a). This mean is represented through an API exposed via standard protocols, such as HTTP, RMI, etc.

d) A mean (invocation) to make the engine (a) create an accessible instance from a process and/or case model, through a defined API, which may be based on standard protocols such as HTTP, RMI, SOAP, etc. This mean may be based on a trigger (event listener), reflected within the process and/or case model, a user interface or a programmatic way (such as an adapter using the defined invocation mean).

e) A mean (external bindings) to invoke defined endpoints and/or web-services or other, to the process and/or case external, defined interfaces.

Given (a) & (c), any changes to artifacts (graph of activities [additions, sequence, removal of activities], type systems [new types and/or removed types and/or changes]) require a deployment or re-deployment of these changes to the engine or an internal redeployment of the process and/orcase model or restart of the affected components.

Non-limiting embodiments of the invention optionally include one or more of a method and framework allowing changes (additions, removals, modifications) to a process and/or workflow and/or case definition at runtime, specifically to:
(a) Its structure (data types), execution graph (transition between activities, such as direct transitions, data and/or context driven gateways) as well as contained activities (such as invocations, transformations, human activities (tasks), event producers and/or consumers); and/or
(b) Connected services and referenced interfaces;

without the need of redeployment of any contained components, restart of deployed components, execution engines, and consequently the migration of process and/or workflow and/or case instance data because of such changes.

A further or alternative non limiting embodiment can include wherein a method and framework is provided for allowing changes (e.g., but not limited to additions, removals, modifications) to a process and/or case and/or workflow and/or case instance during its execution on multiple layers (structure, graph and activities, and the services and interfaces it makes use of) without the need of redeployment of any components, or migration of instance data.

The invention optionally uses ontology to provide a method to reflect changes to a metamodel of one or more of activities, rules, interfaces, and/or types within the engine infrastructure components, as well as physical data type systems, optionally at runtime, which optionally can include one or more of configuring infrastructure components, type systems, and/or includes a method to decouple technical instance states and/or instance data from the physical process and/or workflow and/or case definition and metamodel, and/or UI. These relationships are connecting entities, and are together a generic meta-model for processes and case definitions.

The method and framework allows changes at runtime against a process and/or case instance without the need of redeployment and migration of data, or restart, which involves the solution of at least two (2) problems.

In the first problem, a deployable artifact (or descriptor) is a runtime immutable container of referenced and contained artifacts (as the graph and the type system are contained) and hence creates a natural boundary to changes after its deployment.

The invention solves this first problem by providing a flexible, mutable set of relationships and entities (based on the concept of an ontology), which can be modified at runtime, and is solely interpreted during execution. These relationships are connecting entities, and are together a generic meta-model for processes and case definitions.

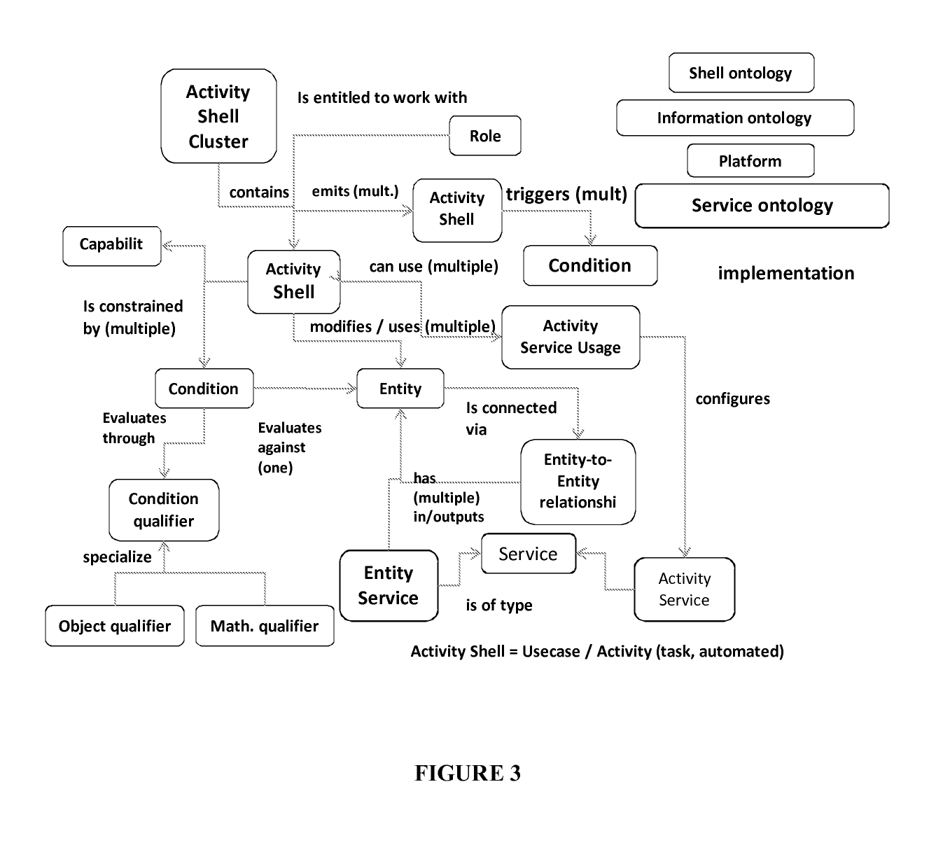

FIG. 3 outlines such a meta-model and its underlying concepts are optionally part of the invention.

The model is based on four interconnected ontologies: a) Shell and/or Activity and/or Usecase ontology—modeling activities, relationships between activities and/or use cases, roles as well as providing means to cluster activities; b) Information ontology—modeling entity (type) definitions and their relationships (these entities store links to physical type definitions and allow a runtime to decipher information objects (physical instances of data) into finer grained objects); c) Platform ontology—modeling rules, pre-conditions and post-conditions that are attached to activities (from (a) above) which are evaluated during runtime; and d) Service ontology—modeling information providers as well as other external interfaces which can be used from within an activity. Infrastructure components (case and/or process engine including bindings, Invocation) listen to the state of the meta-model ontology, and reconfigure themselves upon changes (e.g. changes to the type system (addition of data, types, attributes, and the like), addition of new interfaces, as well as new activities and/or usecases, or rules). As the ontology does not model any transitions in machine code or configuration between activities, but expresses dependencies between those through rules against information and/or data instances at runtime, limiting factors of a process graphs and deployment boundaries can be resolved.

The second problem involves immutable “instance” and/or variable container linked to deployment units (process and/or case graphs).

Inherently a process and/or instance graph makes references to data structures and contents at runtime, through the use of variables. These variables are defined within the graph structure and at runtime persist within the context and instance of a process and/or case and are immutably linked to it. Hence the content as well as the state information is solely owned and accessible by the process and/or case instance it belongs to. Upon any new deployment, the above mentioned data needs to be migrated to the new process and/or case model, in order to continue execution.

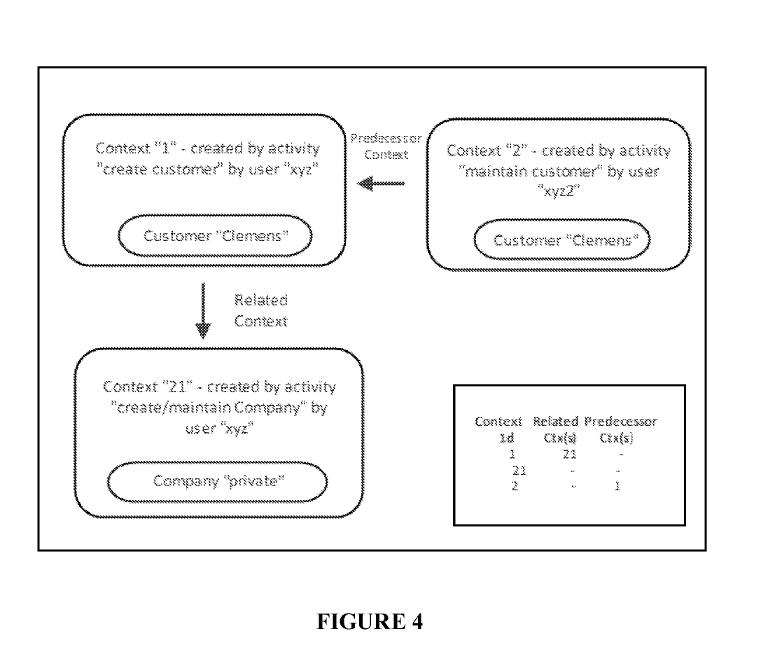

The invention solves the second problem by providing wherein information is solely created during the execution of activities, while being available to any other activity instantly for reuse. Updating information results in a new information object linked to the previous one through an explicit relationship (via ontology). This is possible through two means; (1) storing information within a knowledge base, in a non-relational way, annotated with metadata; and (2) creating and maintaining relationships between an activity instance and the above information object, depicted in FIG. 4.

Through this linkage the algorithm can preserve instances and their modifications over time, and independent of a process and/or case model, solving the problem of instance migration as well as breaking up the natural instance boundary.

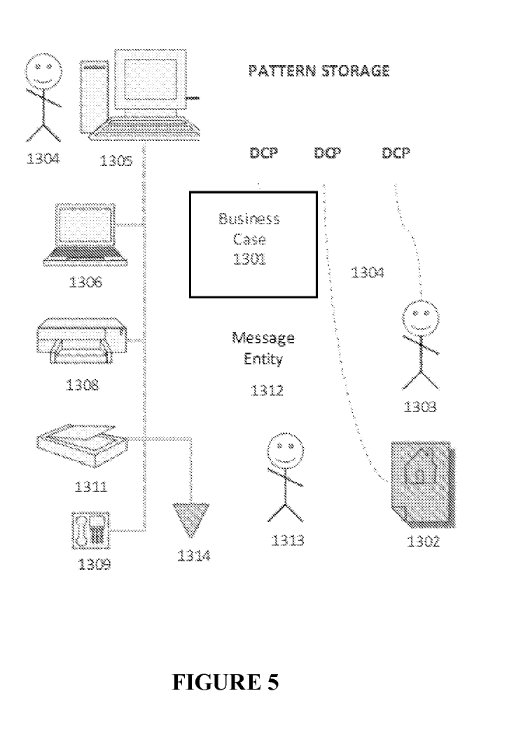

FIG. 5 describes a sample application for business process and/or case management. The operator uses a computer system consisting of multiple processors such as 1305 and 1306 connected by computer network 1310 to model the real world items to UTE patterns storage. The users or machines then interact with the computer system to train the business processes into decision patterns related to descriptive concept patterns (DCP) of persons, real-world items, documents and manual activities.

All items in this diagram are modeled by the operator 1304 by means of keyboard input via the computer 1305 or a machine using the provided Application Programming Interface (API) and its UTE software program as concepts into UTE pattern storage 1307. The concepts of (1301) through (1303) within storage 1307 are just shown as representatives. This modeling includes office devices such as a printer 1308, a scanner 1311 and a telephone 1309, which are mapped to their respective hardware interface and driver program. It includes business internal persons such as the insurance clerk 1313 and a customer person such as 1303 with all their relevant attributes and role information.

To work with those modeled items in the UTE environment they are instantiated (copied with a new GUID) into pattern storage 1307 and populated with case specific data values and referenced to other instances by an authorized user such as insurance clerk 1313 via the display device of computer 1305 as needed, and are for example grouped into a business case such as 1301.

In a state-of-the-art software program these elements are encoded into program code and stored in data base tables or schema-less object storages. There is no distinction between concepts, templates and instances, as the concepts only exist in the program source code and to a lesser extent in the data base table description. To store program interior instances to long-term storage a C++ or Java (or computerized program (program has to serialize its internal data into data base tables. The UTE software does not perform such an operation but simply moves the binary bitmap pattern from the internal memory of computer 1305 to pattern storage 1307.

In this sample application a new business process is encountered that has to be trained. It involves at first the customer 1303 who desires to receive an insurance contract to be provided by insurance clerk 1313. The customer 1303 fills out an application form and sends it to the insurance company using the UTE system via mail, fax, or email.

One of the inbound devices 1308 will receive such a message entity 1312 and store it in pattern storage as an instance of a concept. The UTE software in computer 1305 will start a classification process, open a business case 1301 and attach the inbound pattern of 1312.

The clerk 1313 will now be required to identify the inbound entity 1312 via the display device of computer 1306. The information is stored on disk 1307 by the UTE program in 1305 to build a decision pattern for classification of similar documents.

The clerk 1313 retrieves the necessary concepts from UTE pattern storage (also called the Repository), instantiates them and creates references to the business case 1301.

The clerk 1313 calls program interfaces to external IT systems via an interface connector 1314 to populate the business case and the document with insurance policy data. He retrieves text components to add from the patterns storage. Then he sends the case to a higher authority clerk 1313 (equals references that users inbox pattern) for signoff.

The clerk 1313 routes the document to one of the outbound devices 1308 so that it gets send to the customer 1303.

The UTA learning component of the UTE software in 1305 stores the decision patterns of all the previous actions of clerk 1313 and other persons into disk 1307 in real-time.

The above Steps 5) to 10) will be repeated a number of times. Once enough repetitions of similar actions have been trained the knowledge pattern of the UTA will either decide to perform the action immediately or recommend an action to the role of clerk 1313.

All other processes involving the said components can be trained in the same way. Knowledge patterns are not process bound but atomic and can be reused in different business cases (processes).

One or more embodiments of the invention can thus solve one or more to many problems in addition to the two problems above, e.g., but not limited to, ensuring auditability; providing lifecycles in runtime; providing governance and transparency in the Lifecyle, as well as retrieval of the process instance data

What is claimed is:

1. A computerized method to provide business process or case modeling of business processes or cases, wherein the method reflects changes to a metamodel of activities, rules, interfaces and types within engine infrastructure components and physical data type systems at runtime, by the decoupling of technical instance states and instance data from the physical process or workflow or case definitions and the metamodel modeling the business processes, in order to reflect changes to the metamodel, wherein the business model includes activities, rules, interfaces and types within engine infrastructure components and physical data type systems at runtime,
the computerized method comprising:
a) electronically analyzing on non transitory computer readable media a case or workflow or process engine computer data corresponding to the metamodel of the business processes or cases; the engine electronically translating computer data corresponding to the process or workflow or case models of the business processes during deployment into machine or engine understandable code and configurations provided on said non transitory computer readable media, and during runtime, into data corresponding to physical process or case instances;
b) electronically storing on non transitory computer readable media data provided in a database or computerized storage system, the data corresponding to the state of a running instance including the content of its variables and technical instance states, and that provides tracking of the corresponding data during and after execution states to run modeling of the business processes using the metamodel;
c) electronically deploying on non transitory computer readable media data corresponding to one or more changes or artifacts to the engine provided in step (a), by executing at least one artifact change subroutine provided through an application program interface (API) to;
d) electronically creating data corresponding to an accessible instance from a process or case model through a defined API by providing on non transitory computer readable media at least one invocation subroutine provided through an API that is exposed, via standard protocols, to at least one subroutine that invocates the engine, the invocation subroutine processing data corresponding to initiated by one or more triggers reflected within the process or case model, a user interface (UI), or another subroutine; and
e) electronically providing on non transitory computer readable media at least one external bindings subroutine to invoke or expose invoking or exposing data corresponding to defined endpoints, web-services, or at least one external defined interface by providing on non transitory computer readable media data for executing at least one external bindings subroutine;
wherein the method includes changes comprising additions, removals and modifications to data corresponding to a process or workflow or case definition at runtime,
wherein the method, during its execution on multiple layers, does not include or require: (i) redeployment of contained components; and (ii) restart of: (A) deployed components, (B) execution engines, and (C) the migration of process or workflow or case instance data because of said changes; and
wherein ontologies, comprising one or more of shell, information, platform and service ontologies, are used to provide at least a portion of the metamodel changeable at runtime and includes configuring infrastructure components, systems, a decoupling state, and instance data from the business process or case modeling, case models and user interface (UI);
wherein the relationships between one or more sets of the instance data are solely interpreted during execution as connecting entities, and are together a generic meta-model for the processes and case definitions; and
wherein a deployable process or workflow or case uses artifacts, or a subset of said artifacts, comprising three or more of (i) a process or workflow or case model; (ii) references to external components; (iii) variables; (iv) a deployment descriptor which comprises physical links to process artifacts; and (v) a type model represented through object definitions.

2. A method according to claim 1, wherein said deployable process or workflow or case artifact comprises one or more of service component architecture (SCA), business process model and notation (BPMN), business process execution language (BPEL), or an implementor dependent therein, or a deployable case.

3. A method according to claim 2, wherein the deployable cased is based on case management modeling and notation (CMMN), or an implementor dependent therein.

4. A method according to claim 2, wherein said process or work or case model comprises a process graph with embedded activities selected from human tasks, service invocations, event consumers or providers, and data transformations.

5. A method according to claim 4, wherein said references to external components are selected from one or more of services, adapters, and variables.

6. A method according to claim 5, wherein said variables, based on one or more types of said type model.

7. A method according to claim 1, wherein said deployment descriptor comprises physical links to process artifacts.

8. A method according to claim 7, wherein said process artifacts comprise web services description language (WSDL) documents and wherein the WSDL documents define physical service endpoints.

9. A method according to claim 1, wherein the type model is represented through object definitions locally or referenced from other locations.

10. A method according to claim 9, wherein the object definitions are in the form of one or more of java classes, XML Schemas, or other type definition language.

11. A method according to claim 1, wherein said non transitory computer readable media is provided on at least one selected from a computer processor, a computer, a computer network, a computer server, an API, a website hosting server or network, a mobile device, a WIFI network, a LAN network, a computer network access device, and a personal computer.

12. A method according to claim 1, wherein said business processes are selected from management processes, operational processes and supporting processes.

13. A method according to claim 12, wherein said management processes govern the operation of a system and are selected from corporate governance and strategic management; wherein said operational processes comprise one or more of purchasing, manufacturing, marketing, and sales; and wherein said supporting processes comprise one or more of accounting, recruitment, and technical support

14. A method according to claim 1, wherein the subroutine in step (c) is provided through an API exposed via standard protocols.

15. A method according to claim 1, wherein said changes include (i) changes to artifacts selected from one or more of graph of activities selected from additions, sequence, and removal of activities; and (ii) type systems selected from new types, removed types, and changes, which includes deployment of these changes to the engine.

16. A method according to claim 1, wherein said ontologies comprise at least one of each of (i) a shell or activity or usecase ontology; (ii) an information ontology; (iii) a platform ontology; and (iv) a service ontology.

17. A method according to claim 16, wherein (i) said shell or activity or usecase ontology includes modeling relationships between activities, use cases, and roles, and provides cluster activities; (ii) said information ontology comprises modeling entity (type) definitions and their relationships wherein said entities store links to physical type definitions and allow a runtime to decipher information objects (physical instances of data) into finer grained objects; and (iii) said platform ontology comprises modeling rules and preconditions that are attached to said activities which are evaluated during runtime; and (iv) said service ontology comprises modeling information providers and other external interfaces capable of being used from within an activity; such that infrastructure components monitor the state of the meta-model ontology, and reconfigure themselves upon changes, addition of new interfaces, or new activities or usecases or rules, wherein the ontologies do not model any transitions in machine code or configurations between activities, and expresses dependencies between those through rules against information or data instances at runtime, wherein said process graphs & deployment boundaries are not limiting.

18. A method according to claim 1, wherein said variables are defined within the graph structure and at runtime are linked to the context and instance of a process or case, wherein information is created during the execution of said activities, while being available to any other activity instance for reuse, wherein updating of information results in a new information object linked to the previous one through an explicit relationship via said ontologies, selected from (i) storing information within a knowledge base in a non relational way, annotated with metadata; and (ii) establishing and maintaining relationships between an activity instance and the said information object, wherein by this linkage at least one algorithm can preserve instances and their modifications over time, and independent of said process or case model, such that instance migration is not limiting and the natural instance boundary is not broken up.

19. A computer system to provide business process or case modeling of business processes, wherein the method provides for the decoupling of technical instance state and instance data from the phyical process or workflow or case definitions and the meta-model modeling the business processes, in order to reflect changes to a metamodel of the business processes, including wherein the business model includes activities, rules, interfaces and types within engine infrastructure components and physical data type systems at runtime, the computerized method comprising:
a. a computerized system component electronically analyzing on non transitory computer readable media a case or workflow or process engine computer data corresponding to the metamodel of the business processes or cases; the engine electronically translating computer data corresponding to the process or workflow or case models of the business processes during deployment into machine or engine understandable code and configurations provided on said non transitory computer readable media, and during runtime, into data corresponding to physical process or case instances;
b. a computerized system component electronically storing on non transitory computer readable media data provided in a database or computerized storage system, the data corresponding to the state of a running instance including the content of its variables and technical instance states, and that provides tracking of the corresponding data during and after execution states to run modeling of the business processes using the metamodel;
c. a computerized system component electronically deploying on non transitory computer readable media data corresponding to one or more changes or artifacts to the engine provided in step (a), by executing at least one artifact change subroutine provided through an application program interface (API) to;
d. a computerized system component electronically creating data corresponding to an accessible instance from a process or case model through a defined API by providing on non transitory computer readable media at least one invocation subroutine provided through an API that is exposed, via standard protocols, to at least one subroutine that invocates the engine, the invocation subroutine processing data corresponding to initiated by one or more triggers reflected within the process or case model, a user interface (UI), or another subroutine; and
e. a computerized system component electronically providing on non transitory computer readable media at least one external bindings subroutine to invoke or expose invoking or exposing data corresponding to defined endpoints, web-services, or at least one external defined interface by providing on non transitory computer readable media data for executing at least one external bindings subroutine;
wherein the system includes changes comprising additions, removals and modifications to data corresponding to a process or workflow or case definition at runtime,
wherein the system, during execution on multiple layers, does not include or require: (i) redeployment of contained components; and (ii) restart of: (A) deployed components, (B) execution engines, and (C) the migration of process or workflow or case instance data because of said changes; and
wherein ontologies, comprising one or more of shell, information, platform and service, is used to provide at least a portion of the metamodel capable of being changed at runtime and includes configuring infrastructure components, systems, and a decoupling state, instance data from the business process or case modeling, case models and user interface (UI);
wherein the relationships between are solely interpreted during execution as connecting entities, and are together a generic meta-model for processes and case definitions;
wherein a deployable process or workflow or cases artifact uses artifacts, or a subset of said artifacts, comprising (i) a process or case model; (ii) references to external components; and (iii) variables; (iii) a deployment descriptor, which contains physical links to process artifacts; and (iv) a type model, represented through object definitions.
